(19) United States
(12) Patent Application Publication
(10) Pub. No.: US 2015/0130817 A1
(43) Pub. Date: May 14, 2015

(54) GENERATING A SIDEBAR FROM VECTOR TILES

(71) Applicant: GOOGLE INC., (US)

(72) Inventors: Benjamin C. Appleton, Summer Hill (AU); James McGill, NSW (AU)

(73) Assignee: GOOGLE INC., Mountain View, CA (US)

(21) Appl. No.: 13/686,615

(22) Filed: Nov. 27, 2012

Related U.S. Application Data
(60) Provisional application No. 61/664,914, filed on Jun. 27, 2012.

(51) Int. Cl. G06T 1/00

(52) U.S. Cl. CPC G06T 1/00
USPC 345/501

(57) ABSTRACT

Client-side and server-side methods and apparatuses for displaying, proximate a map viewport, a sidebar having information corresponding to features depicted within the map viewport. In an example, a method includes receiving into a processor one or more map tiles for use in displaying a geographic region in a map viewport of the map display interface, where at least one map tile includes one or more depicted map features of the geographic region. The method further includes receiving, for each of the one or more received map tiles, a corresponding map data tile including associated data for each depicted map feature. The method also includes causing the one or more map tiles to be displayed in the map viewport and causing at least a portion of the associated data for each of the depicted map features determined to be within the map viewport to be displayed in a sidebar associated with the map viewport.

### FIELD OF DISCLOSURE

This disclosure relates to displaying, proximate a map viewport, a sidebar having information corresponding to map features depicted within the map viewport.

### BACKGROUND

Software applications, including web browsers, may be used to view map data provided by network servers. For example, a user may use a web browser to search an online mapping service for map data, including, for example, map features such as locations of businesses. In response to the user's search, a map viewport may be displayed in the web browser. This map viewport may include one or more of geo-referenced map features related to the user's search.

The software applications may also include a sidebar for displaying information associated with features displayed in the map. For example, the sidebar may include a list of map features or other data related to a user's search. However, the list displayed in the sidebar typically includes many more items than those displayed in the map viewport. This includes items outside the geographic bounds of the map currently displayed in the map viewport. This may negatively affect the user's experience, for example by overloading the user or the software application with more information than is needed given the display in the map viewport. Furthermore, this may cause a client device to use more resources (e.g., memory) than necessary to perform a specific operation.

Consider, for example, FIG. 1 which illustrates a prior art system 10. In the prior art system, a server transmits map tiles to a viewing client. Each map tile corresponds to a specific geographical region at a particular zoom level. At higher zoom levels, at which each map tile corresponds to a smaller geographical region, there may be fewer map features within the geographical region depicted by each map tile. Accordingly, at higher zoom levels the geographical region depicted in a given viewport will include relatively fewer map features. Correspondingly, at lower zoom levels, at which each map tile corresponds to a larger geographical region, there may be many more map features within the geographical region depicted by each map tile. In some instances, the server may depict in each map tile all of the map features within the geographical area represented by the map tile. In other instances, the server may depict in each map tile only some of the map features within the geographical area represented by the map tile. Such filtering of the depicted map features may be accomplished for the purposes of readability, highlighting search results, etc.

In any event, in the prior art system, the viewing client sends to the server a request for map features in the geographical region depicted within the viewport. In response to the request, the server transmits all of the map features in the geographical region and, in some instances, all of the map features within the geographical region represented by any of the map tiles depicted within the viewport. Thus, a sidebar generated from the map feature information sent by the server may include map features that are outside of the viewport where a portion of a tile is in the viewport and a portion of the tile is outside of the viewport. Additionally, in an instance where a map tile does not depict some map features in the geographical region represented by the map tile (e.g., where map features have been removed for readability), the map feature data transmitted to the viewing client will still include the map features that are not depicted and, accordingly, the sidebar will include data for map features that are not depicted.

FIG. 1 includes a map viewport 14 and a map sidebar 12. The map viewport 14 shows a map depicting a single map feature 16. However, the map sidebar 12 shows map features 1-21 out of a total of 1000 map features, even though the map viewport 14 displays only the single map feature 16. The 1000 total map features are, in some cases, outside the boundaries of the map viewport 14. In other cases, the map features are not displayed due to a data filter being applied. FIG. 1, therefore, illustrates that there may be no correspondence between the number of map features shown in a map viewport 14 and the number of map features listed in a map sidebar 12.

### BRIEF SUMMARY

In accordance with an example of the present disclosure, a method of generating sidebar content in a map display interface is presented. The method includes receiving into a processor one or more map tiles for use in displaying a geographic region in a map viewport of the map display interface, where at least one map tile includes one or more depicted map features of the geographic region. The method further includes receiving into the processor one or more map data tiles, each map data tile corresponding to one of the one or more map tiles and including map feature data for each depicted map feature on the corresponding map tile. The method also includes determining, using the processor, a set of the one or more map tiles depicted in the map viewport, using the processor to cause the set of one or more map tiles to be displayed in the map viewport, and using the processor to create a sidebar using map feature data from the map data tiles corresponding to the set of one or more map tiles displayed in the map viewport. The method also includes displaying the sidebar proximate the map viewport.

In accordance with another example of the present disclosure, a computer-readable storage medium having stored thereon instructions executable by a processor to perform a method of generating sidebar content in a map display interface is presented. The computer-readable storage medium also includes instructions executable by the processor for receiving into the processor one or more map tiles for use in displaying a geographic region in a map viewport of the map display interface, where at least one map tile includes one or more depicted map features of the geographic region. The computer-readable storage medium also includes instructions executable by the processor for receiving into the processor one or more map data tiles, each map data tile corresponding to one of the one or more map tiles and including map feature data for each depicted map feature on the corresponding map tile. The storage medium also includes instructions for determining, using the processor, a set of the one or more map tiles depicted in the map viewport, determining whether each of the set of map features is within a geographic region depicted within the map viewport, and creating a sidebar using map feature data from the map data tiles corresponding to the set of one or more map tiles displayed in the map viewport and displaying the sidebar proximate the map viewport.

In accordance with an example of the present disclosure, another method of generating sidebar content in a map display interface is presented. The method includes receiving at a processor a request for map data for a geographic region; the processor determining, in response to the request, a set of one or more map tiles corresponding to the geographic region of the request; and the processor determining a set of map features to include in the one or more map tiles corresponding to the geographic region of the request. The method further includes the processor sending to a client device a corresponding set of one or more map data tiles, each map data tile corresponding to a map tile and including map feature data for each of the map features in the corresponding map tile.

### BRIEF DESCRIPTION OF THE DRAWINGS

The present disclosure may be better understood with reference to the accompanying drawings, in which:

FIG. 1 illustrates a prior art system that could benefit from the present disclosure;

FIG. 2 illustrates an example system in which the techniques of the present disclosure can be implemented;

FIG. 3 illustrates component modules that may be found inside a client device implementing one or more of the methods of the present disclosure;

FIG. 4 illustrates component modules that may be found inside a server device implementing one or more of the methods of the present disclosure;

FIG. 5 illustrates a map viewport and sidebar according to the present disclosure;

FIG. 6 illustrates a flow chart of an example client-side method according to the present disclosure; and

FIG. 7 illustrates a flow chart of an example server-side method according to the present disclosure.

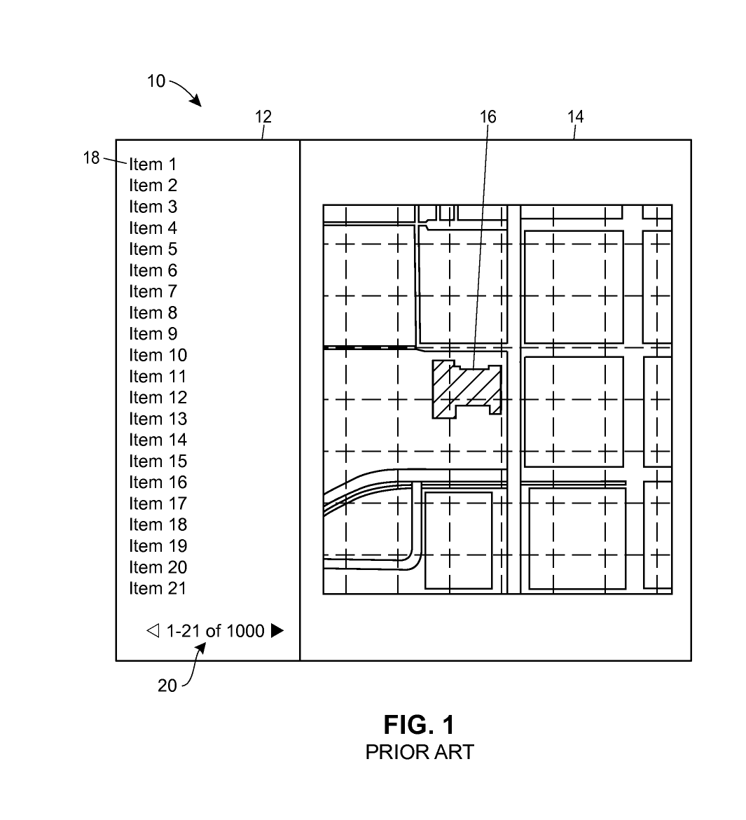

### DETAILED DESCRIPTION

Generally speaking, a sidebar is displayed proximate a map viewport, the sidebar including information directly related to corresponding map features contemporaneously depicted within the map viewport. In the examples below, information and map features that do not correspond to features depicted in the map viewport are, in most circumstances, not depicted in the sidebar. Furthermore, as a user varies the display in the viewport by panning or zooming, for example, the information populated in the sidebar changes accordingly to reflect the map features depicted in the map viewport. The present disclosure, therefore, includes examples of systems and methods for displaying, proximate a map viewport, a sidebar having information corresponding to features depicted within the map viewport.

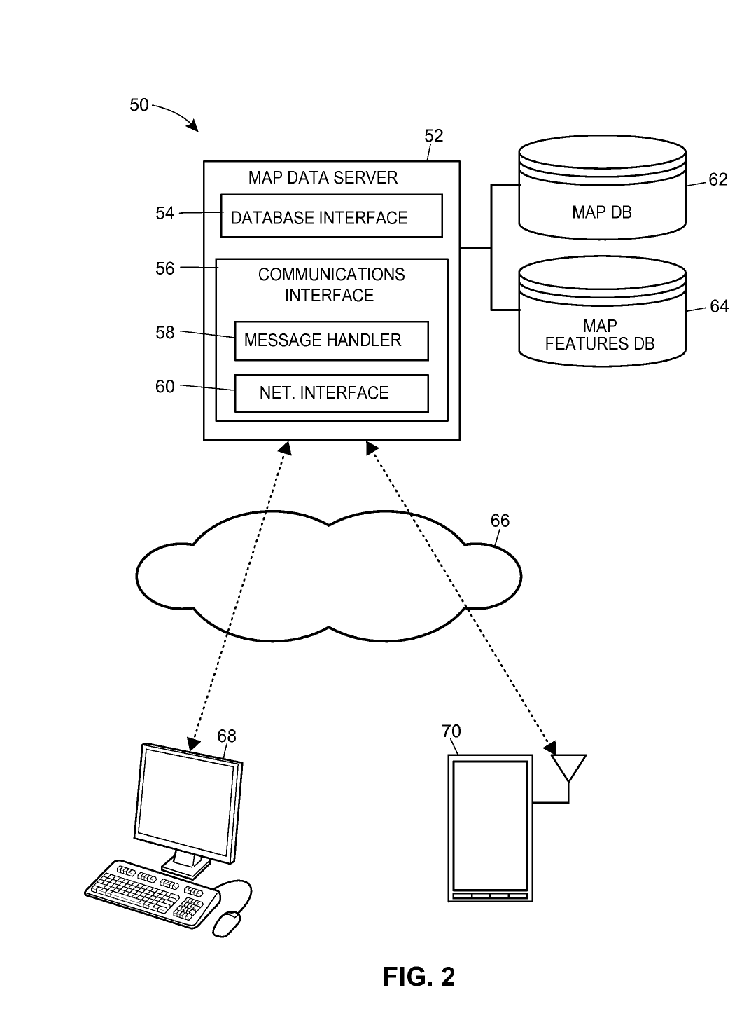

With reference to FIG. 2, a system 50 according to an example of the present disclosure is presented. The system 50 includes one or more computers 68 and/or mobile devices 70 in communication with a map data server 52. The computer 68 may be a desktop computer, a portable computer, or any other general-purpose computing device. The mobile device 70 may be a smartphone, a tablet computer, a navigation system built into a vehicle, etc. The map data server 52 may be implemented as a single device or a group of devices using any suitable hardware and software components. The map data server 52 is configured to communicate with the one or more computers 68 and/or one or more mobile devices 70 via a communications interface 56 and a communication network 66, which may be a wide area network such as the Internet, for example. The communications interface 56 may include a message handler interface 58 for sending and receiving communications messages over the network interface 60.

In an example, the computer 68 or mobile device 70 may be configured to access map data from a local storage device. The local storage device may be, for example, a hard drive, a solid-state memory, a compact disc (CD), a digital versatile disc (DVD), or any storage device accessible by a local data or network connection.

With continued reference to FIG. 2, the map data server 52 may use a database interface 54 to access map data from a map database 62 and/or a map features database 64 for sharing the map data with the one or more computers 68 or mobile devices 70. In an example implementation, each of the databases 62, 64 is a relational database implemented as a set of electronic data records stored on computer-readable medium in a respective server or group of servers, some of which may be maintained by different operators and interfaced with using an application programming interface (API). For example, a map features data provider may operate the map features database 64 and provide an API for accessing and retrieving the desired data. As another example, the databases 62, 64 may be provided as a single electronic database.

In general, the map database 62 can store map data in one or more formats, including different types of raster-formatted data and vector-formatted data. Raster data, including bitmap data, is generally characterized by one or more arrays of individual data points or data tuples. Vector data, on the other hand, is generally characterized by geometric objects such as points, lines, polylines, and polygons. Raster data tends to require more storage space and, therefore, more communications bandwidth compared to vector data. However, raster data may be better suited for aerial imagery, whereas vector data may be better suited for road data and data formatted as one or more geometric shapes.

In example scenarios, the map database 62 may be configured to provide to the map data server 52 vector and/or raster map tiles. The map tiles may take the form of any geometric shape, including, for example, squares and rectangles, and possibly one or more quadtrees.

Map features may also be represented with vector data. For example, a map feature may be a single geo-referenced point. This geo-referenced point may include metadata associated with the point, including, for example, a name, a street address, a telephone number, a website URL, a type of business, hours of operation, etc. In another example, the map features may be represented by one or more polylines or polygons. For example, routes and paths may be represented as polylines, and buildings may be represented as polygons.

In an example configuration of the map features database 64, a map feature may be associated with one or more of the vector and/or raster map tiles in the map database 62. In another example configuration, the map features in the map features database 64 may each be associated with local or global coordinates in a respective local or global coordinate system. The map features database 64 may be configured to respond to queries from the map data server 52, for example, to return map features for a region specified in the query. In a further example configuration, the map features database 64 may be configured to return specific types of map features or return map features of a specified name. In a further example configuration of the map features database 64, the map features database 64 may be configured to return specific map features within an area represented by one or more map tiles in the map database 62. As described below, the map feature data may be organized into one or more map data tiles, each of which may correspond to a map tile, and each of which may include map feature data for map features depicted in the corresponding map tile. In some implementations of the system, specifically where the system is a vector based system sending map tiles as vector data, the map data tiles may be the same as the map tiles. In other implementations, where the system is a graphical or raster-based system, the map tiles (which may also be referred to as map raster tiles or map graphical tiles in such a system) may be different from the map data tiles.

In another example configuration, the map features database 64 may be configured to filter or “thin” the number of map features included within the map data tiles prior to transmitting map data from the map data server 52 to the client device 68, 70.

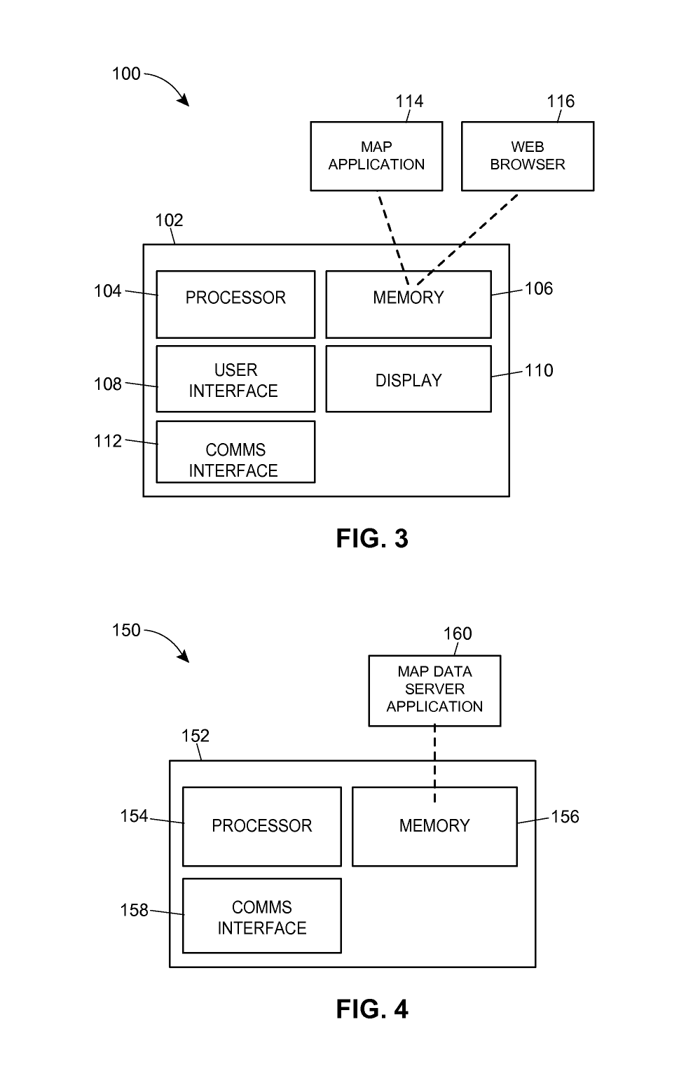

Now referring to FIG. 3, the computer 68 or mobile device 70 of FIG. 2 may include a number of modules, for example modules 104-110 of a computing device 100. In an example, the computing device 100 includes one or several processors 104 in communication with a computer-readable memory 106. For simplicity, the computer-readable memory 106 is illustrated in FIG. 3 as a single component. However, it will be understood that the computing device 100 may include both persistent memory such as a hard disk and volatile memory such as random-access memory (RAM). The computing device 100 also includes a user interface module 108 to receive input from a user and a display 110 to present output from the computing device 100 to a user. More generally, the computing device 100 may be equipped with any suitable input, output, and input/output (e.g., a touchscreen) components.

A user of the computer 68 or mobile device 70 may use a software application (e.g., a web browser) to allow the user to view map data from the map data server 52. For example, with reference to the computing device 100, a map application 114 or web browser 116 may be stored in the memory 106 and executed on the processor 104 to request and receive map data via a communications interface 112, process the map data to render map images and a sidebar on the display 110, and variously adjust the map images in response to user commands provided via the user interface 108, etc.

Now referring to FIG. 4, the map data server 52 of FIG. 2 may include a number of modules, for example modules 154-158 of the server 150. In an example, the server 150 includes one or several processors 154 in communication with a computer-readable memory 156. For simplicity, the computer-readable memory 156 is illustrated in FIG. 4 as a single component. However, it will be understood that the server 150 may include both persistent memory such as a hard disk and volatile memory such as random-access memory (RAM).

The server 150 may include one or more software applications to allow the server 150 to respond to map data requests from the computing device 100. In an example, the map data server application 160 may be configured to receive and respond to map data requests over a communications interface 158. In particular, the server 150 may respond to a request by generating map tiles according to the request received from the computing device 100. For example, the server 150 may retrieve map data from the map database 62 and generate map tiles at a particular zoom level and including specific map features (e.g., restaurants, hotels, parks, etc., as in response to a search request). Alternatively, the server 150 may retrieve map data from the map database 62 and generate map tiles at a particular zoom level and including general map features (e.g., general points of interest). In still another example, the server 150 may retrieve map tiles already generated and stored in the map database 62. In any event, the server 150 may transmit the map tiles to the requesting computing device 100.

The server 150 may also retrieve map data tiles from the map features database 64, or may generate map data tiles from data retrieved from the map features database 64. Each map data tile may correspond to one of the map tiles. Specifically, for a given map tile, depicting a set of map features, a corresponding map data tile may include data for each of the map features depicted on the map tile. That is, if a map tile depicts three map features (e.g., Chinese restaurants), the corresponding map data tile will include data (e.g., name, phone number, address, rating, etc.) for the three map features. The server 150 may transmit the map data tiles to the requesting computing device 100 with the map tiles.

Upon receiving the map tiles and the map data tiles, the map application 115 operating on the computing device 100 may display the map tiles in a map viewport. The map application 115 may also generate a sidebar from the map data tiles, and cause the sidebar to be displayed, as described in greater detail below. By generating the sidebar from the map data tiles, the number of features displayed in the sidebar is bounded by the number of features displayed in the viewport. Thus, in an instance where map tiles are generated with fewer map features than may be present in the geographical region corresponding to each map tile, the sidebar will include data for correspondingly fewer map features.

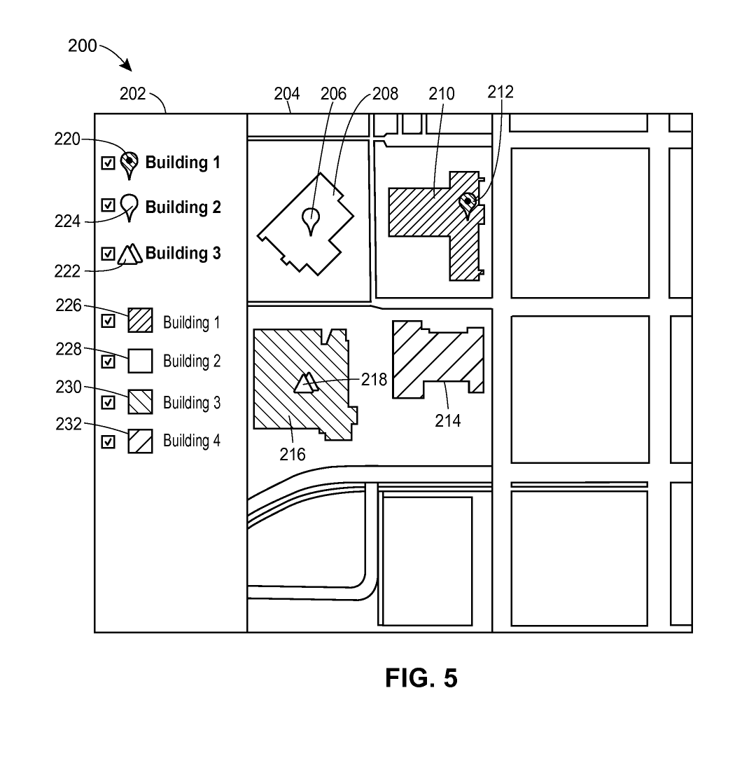

With reference to FIG. 5, an example of a map viewport 204 with a sidebar 202 according to the present disclosure is presented. The map viewport 204 and sidebar 202 may be displayed in response to a user's query. In this example scenario, when the user queries an online map service for information (e.g., restaurants in a geographic area), the map service may provide the user with the map viewport 204 displaying one or more map features 206-218 within the viewport 204. In addition, the map service may provide the sidebar 202 associated with the map viewport 204, where the sidebar 202 includes a list of map features 220-232 corresponding to the map features 206-218 depicted in the map viewport 204. Here, there is direct correspondence between map features 206-218 depicted in the map viewport 204 and the list of map features 220-232. For example, the building represented by map feature 208 in the map viewport 204 corresponds to item 226 in the list of map features 206-232 in the sidebar 202.

In another example configuration, the sidebar 202 may include, in addition to map features 206-218 depicted in the viewport 204, map features close to, but otherwise outside of the geographic boundaries associated with the map viewport 204.

In an example scenario, information in the sidebar 202 may be generated within the client device 68, 70 while or after the map tiles and the map data tiles are received. Alternatively, the sidebar 202 may be generated after the map data tiles are received. In another example scenario, the map data server 52 may itself generate the list of map features 220-232 to be displayed in the sidebar 202. In an example, the map data server 52 may generate the sidebar 202 as an image or one or more image tiles to be sent to a client device 68, 70. In either event, a determination is made as to which map features 206-218 coincide with the current map viewport 204, and information related to those map features 206-218 is included within the sidebar 202.

In an example scenario, as the user zooms, pans, rotates, or otherwise changes the map in the map viewport 204, the content of the sidebar 202 is automatically revised based upon the current features contained within the corresponding map viewport 204.

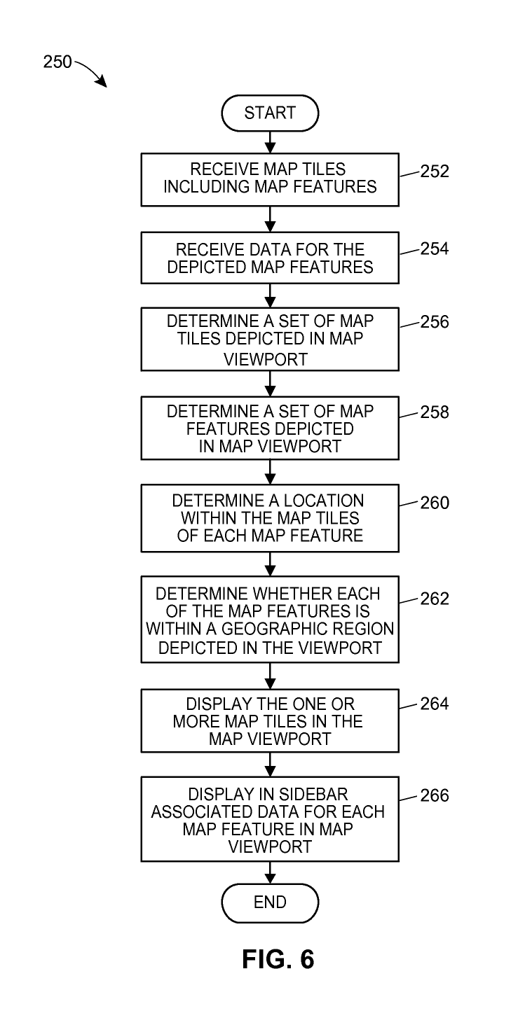

FIG. 6 illustrates an example method 250 for receiving from a map data server 52 one or more map tiles for use in displaying a map viewport 204 including a map of a geographic region and a sidebar 202 and one or more map data tiles including information related to map features in the geographic region represented by the corresponding map tiles. While the blocks of the method 250 are illustrated in a particular order and may be described in a particular order, some of the blocks of the method 250 may be performed in a different order or may be performed substantially simultaneously with other blocks. Further, some of the operations in the blocks of the method 250 may be separated into one or more distinct operations.

In the example method 250, the processor 104 receives from the map data server 52 one or more map tiles (block 252). The one or more map tiles may be formatted as either vector or raster map data and may include one or more depicted map features in the geographic region represented by the one or more map tiles. The processor 104 may cause the one or more map tiles to be stored in the computer-readable medium 106, after which the processor 104 may selectively retrieve the one or more map tiles from the computer-readable medium 106.

The processor 104 may receive one or more corresponding map data tiles each including map feature data associated with the one or more depicted map features (block 254). This map feature data may include any type of metadata associated with the map features (e.g., a business name, a street address, business hours). The processor 104 may store the map data tiles in the computer-readable medium 106, after which the processor 104 may selectively retrieve the one or more map data tiles associated with the one or more map tiles depicting map features.

The processor may receive a request for map data of a geographic region. In response to the request, the processor 104 may be caused to retrieve one or more of the map tiles from the computer-readable medium 106 to determine a set of the one or more map tiles depicted in the map viewport 204 (block 256). The processor 104 may use, for example, a geographic coordinate of the center of the map viewport 204 and a zoom level to determine the geographic coordinates of each of the corners of the map viewport 204. Alternatively or in addition, the processor 104 may generate a mathematical representation of the lines that form the boundaries of the map viewport 204. This mathematical representation may be useful, for example, for allowing the processor 104 to determine whether a geographic point is within or outside the geographic boundaries represented by the map viewport 204. In addition, the mathematical representation may be useful for allowing the processor 104 to determine which map tiles are completely or partially within the geographic boundaries represented by the map viewport 204.

The processor 104 may determine which map features are currently depicted in the map viewport 204 (block 258). In some situations, map features may be filtered (at the server 52 or the computing device 100) to prevent the features from being depicted in the map viewport 204. This process is also known as thinning. Thinning may be useful when there is a significant number of map features displayed in a relatively small geographic area. For example, in a scenario where a map viewport 204 shows a zoomed-out view of a geographic area, the map features of the geographic area may be displayed with many map features overlaying other map features. This can have a negative effect on user experience. To address this issue, some of the map features may be thinned in order to reduce the number of map features depicted at a particular zoom level. Thinning may also be based on other criteria related to the map features. For example, the depicted map features may be thinned based on business type, business hours, service availability, etc.

The processor 104 may determine the location, within the one or more map tiles, of each of the set of map features (block 260). In an example implementation, the location of each map feature may be stored as a global position tuple including at least one latitude value and at least one longitude value associated with the map feature. In another example implementation, the location of each map feature may be stored as a local position tuple including one or more local coordinates of a coordinate system local to a specific map tile. For example, the location of a map feature may be described in Cartesian or polar coordinates with reference to an origin established at any point within a map tile (e.g., a corner).

The processor 104 may determine whether each of the set of map features is within a geographic region depicted within the map viewport 204 (block 262). This determination may be accomplished, for example, by calculating whether the geographic coordinates of a point are within the geographic boundaries associated with the map viewport 204. In another scenario, the determination may be made by aggregating the map features associated with each of the one or more map tiles that are determined to be completely or partially within the geographic boundaries represented by the map viewport 204.

The processor 104 may cause the set of one or more map tiles to be displayed in the map viewport 204 (block 264). In addition, the processor 104 may generate from the map data tiles, and cause to be displayed, a sidebar including at least a portion of the associated data for each of the depicted map features determined to be within the map viewport (block 266).

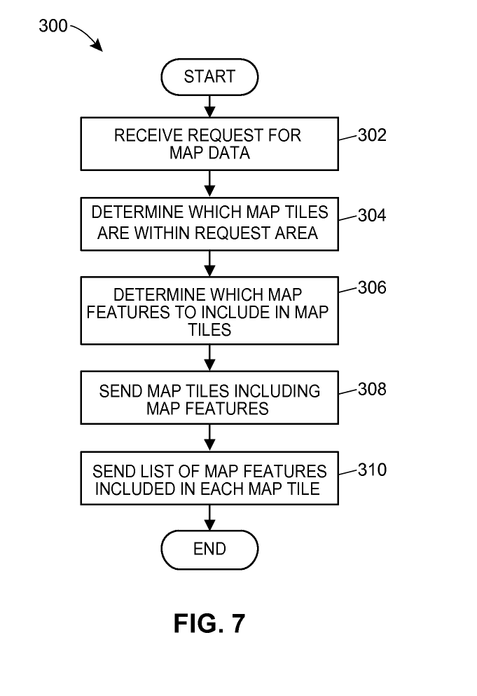

With reference to FIG. 7, a method 300 is illustrated where a number of the operations of the method 250 that are performed by a client device 68, 70 are instead performed on the map data server 52, for example. Using a server 52, 152 to perform these operations rather than using the client device (e.g., computer 68, mobile device 70) to perform the operations may save computational and memory resources on the client device 68, 70. While the blocks of the method 300 are illustrated in a particular order and may be described in a particular order, some of the blocks of the method 300 may be performed in a different order or may be performed substantially simultaneously with other blocks. Further, some of the operations in the blocks of the method 300 may be separated into one or more distinct operations.

Referring still to FIG. 7, the processor 154 in the server 150 (e.g., the map data server 52) may receive from a client device (e.g., a computer 68 or a mobile device 70) a request for map data (block 302). The request for map data may include a request for map data of a specific geographic region. In an example configuration, the geographic region is the region represented by a map viewport 204 of the client device 68, 70. Furthermore, the request may include a request for specific types of map features to be included in the map data.

The processor 154 may determine which map tiles are within the area specified in the request (block 304). The processor 154 may use a mathematical representation or other geometric operation to determine which map tiles are within the area specified in the request.

The processor 154 may determine which map features to include in the map tiles to be sent to the client device 68, 70 in response to the client device's request (block 306). In example scenarios, some of the map features may be excluded from the map tiles to be sent to the client device 68, 70 using the above-described thinning process.

The processor 154 may send the map tiles, including the map features, to the client device (block 308). In addition, the processor 154 may send a list of the map features 206-218 included in each of the map tiles (block 310). This list could be used to populate the sidebar 202 with information about the map features 206-218 depicted in the map viewport 204, according to the present disclosure. The list may include one or more of an identifier, a name, or a description, for example. While not as efficient, in some implementations, the list of map features may include all of the map features in the viewport. However, it is frequently more efficient to send the map features on a per-tile basis (i.e., as map data tiles), especially during operations such as panning, in which data for only a few new tiles may be required. The processor 154 may also, in some examples, send the sidebar as rendered tiles. Alternatively, the sidebar may be paginated, independently of the map.

In each of the foregoing examples of the present disclosure, it may be beneficial to include in the sidebar 202 information about map features that are outside of but close to the geographic boundaries represented by the boundaries of the map viewport 204. Therefore, in an example implementation, a geographic buffer may be established extending from the geographic boundaries represented by the boundaries of the map viewport 204. For example, the geographic buffer may be configured to extend a fixed distance (e.g., 5 miles) outside the boundaries of the viewport 204. Map features that fall outside of the area displayed in the viewport 204 but within the 5-mile buffer may be included in the information displayed in the map sidebar 202.

In other example implementations, the offset of the geographic buffer from the boundaries of the map viewport 204 may change based on a zoom level. For example, at higher zoom levels where a smaller geographic area is displayed a map viewport 204, the geographic buffer may be relatively small in distance. At lower zoom levels, however, the geographic buffer may be much larger in distance.

In still another example implementation, tiles adjacent to the map viewport 204 may be buffered. In such an implementation, the buffer has similar properties to those described above, namely, at higher zoom levels, the buffer is a smaller geographic distance.

Each of the foregoing geographic buffer examples may be achieved by establishing the geographic buffer length as a set percentage of a horizontal or a vertical distance represented in the map viewport 204. For example, if the geographic buffer were established to be 10% of the horizontal or vertical distance of the map viewport 204, and if at a high zoom level the map viewport displays a map representing a 5-mile by 5-mile area, the geographic buffer would extend 0.5 miles from the geographic borders represented by the map viewport. If, however, the map viewport shows a map at a lower zoom level, for example, the map displaying 100-mile by 100-mile area, then the geographic area would extend 10 miles from the geographic border represented by the map viewport 204. Therefore, any non-thinned map features within the 10 mile geographic border would be displayed in the sidebar 202.

In an example, the distance of the buffer may be predetermined by the map data server 52, the computer 68, the mobile device 70, or an external device or process.

While the above examples were described with reference to map data, the methods of the present disclosure may be applied to any kinds of two-dimensional, two-and-a-half-dimensional, or three-dimensional data.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain examples are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In examples, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one example” or “an example” means that a particular element, feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. For instance, some examples may be described using the term “coupled” to indicate that two or more elements are in direct physical or electrical contact. The term “coupled,” however, may also mean that two or more elements are not in direct contact with each other, but yet still co-operate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the examples herein. This is done merely for convenience and to give a general sense of the invention. This description should be read to include one or at least one and the singular also includes the plural unless it is obvious that it is meant otherwise.

Upon reading this disclosure, those of ordinary skill in the art will appreciate still additional alternative structural and functional designs for systems, apparatus, and processes to display, proximate a map viewport, a sidebar having information corresponding to features depicted within the map viewport through the principles disclosed herein. Thus, while particular examples and applications have been illustrated and described, it is to be understood that the disclosed examples are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of generating sidebar content in a map display interface, the method comprising:
receiving into a processor one or more map tiles for use in displaying a geographic region in a map viewport of the map display interface, at least one map tile including one or more depicted map features of the geographic region;
receiving into the processor one or more map data tiles, each map data tile corresponding to one of the one or more map tiles and including map feature data for each depicted map feature on the corresponding map tile;
determining, using the processor, a set of the one or more map tiles depicted in the map viewport;
using the processor to cause the set of one or more map tiles to be displayed in the map viewport;
creating, using the processor, a sidebar using map feature data from the map data tiles corresponding to the set of one or more map tiles displayed in the map viewport; and
displaying the sidebar proximate the map viewport.

2. The method of claim 1 further comprising using the processor to update the map feature data in the sidebar when the map viewport is updated.

3. The method of claim 1, wherein the one or more depicted map features comprise a reduced set of the total features associated with the geographical region corresponding to the map tile.

4. The method of claim 1 further comprising:
determining, using the processor, a set of map features depicted in the map viewport;
determining, using the processor, the location within the one or more map tiles of each of the set of map features; and
determining, using the processor, whether each of the set of map features is within a geographic region depicted within the map viewport.

5. The method of claim 1, wherein the one or more depicted map features correspond to results of a search request.

6. The method of claim 5, wherein the search request includes one of a business name, a business type, business hours, and service availability.

7. The method of claim 1, wherein receiving the map data tiles corresponding to the map tiles further includes receiving map tiles and map data tiles associated with a buffer zone extending out a predetermined distance from a perimeter of the geographic region.

8. A computer-readable storage medium having stored thereon instructions executable by a processor to perform a method of generating sidebar content in a map display interface, the method comprising:
receiving into the processor one or more map tiles for use in displaying a geographic region in a map viewport of the map display interface, at least one map tile including one or more depicted map features of the geographic region;
receiving into the processor one or more map data tiles, each map data tile corresponding to one of the one or more map tiles and including map feature data for each depicted map feature on the corresponding map tile;
determining, using the processor, a set of the one or more map tiles depicted in the map viewport;
using the processor to cause the set of one or more map tiles to be displayed in the map viewport;
creating, using the processor, a sidebar using map feature data from map data tiles corresponding to the set of one or more map tiles displayed in the map viewport; and
displaying the sidebar proximate the map viewport.

9. The computer-readable storage medium of claim 8 further comprising instructions to cause the processor to update the map feature data in the sidebar when the map viewport is updated.

10. The computer-readable storage medium of claim 8, wherein the one or more depicted map features comprise a reduced set of the total features associated with the geographical region corresponding to the map tile.

11. The computer-readable storage medium of claim 8 further comprising instructions to cause the processor to:
determine, using the processor, a set of map features depicted in the map viewport;
determine, using the processor, the location within the one or more map tiles of each of the set of map features; and
determine, using the processor, whether each of the set of map features is within a geographic region depicted within the map viewport.

12. The computer-readable storage medium of claim 8, wherein the one or more depicted map features correspond to results of a search request.

13. The computer-readable storage medium of claim 12, wherein the search request includes one of a business name, a business type, business hours, and service availability.

14. The computer-readable storage medium of claim 8, wherein receiving the map data tiles corresponding to the map tiles further includes receiving map tiles and map data tiles associated with a buffer zone extending out a predetermined distance from a perimeter of the geographic region.

15. A method of generating sidebar content in a map display interface, the method comprising:
receiving at a processor a request for map data for a geographic region;
the processor determining, in response to the request, a set of one or more map tiles corresponding to the geographic region of the request;
the processor determining, a set of map features to include in the one or more map tiles corresponding to the geographic region of the request;
the processor sending to a client device the set of one or more map tiles including the set of map features; and
the processor sending to the client device a corresponding set of one or more map data tiles, each map data tile corresponding to a map tile and including map feature data for each of the map features in the corresponding map tile.

16. The method of claim 15, wherein the geographic region of the request corresponds to a geographic region of a map viewport.

17. The method of claim 15, wherein the geographic region is determined from a geographic coordinate and a zoom level included in the request for map data.

18. The method of claim 15, wherein the one or more depicted map features correspond to results of a search request.

19. The method of claim 18, wherein the search request includes one of a business name, a business type, business hours, and service availability.

20. The method of claim 15, wherein sending to the client device a corresponding set of map data tiles further includes sending map data tiles corresponding to map tiles associated with a buffer zone extending out a predetermined distance from a perimeter of the geographic region of the request.
